(19) United States
(12) Patent Application Publication
(10) Pub. No.: US 2019/0184724 A1
(43) Pub. Date: Jun. 20, 2019

(54) METHOD AND APPARATUS FOR CHAOSMETRIC BRAND PROTECTION WITH FLUORESCENT TAGGANT

(71) Applicant: Jaroslav Hook, Melbourne, FL (US)

(72) Inventor: Jaroslav Hook, Melbourne, FL (US)

(21) Appl. No.: 15/847,912

(22) Filed: Dec. 20, 2017

(51) Int. Cl. B41M 3/14; G01N 21/64; G07D 7/121; G07D 7/005; B42D 25/391

(52) U.S. Cl. CPC B41M 3/144; G01N 21/643; B42D 25/391; G07D 7/005; G07D 7/121

(57) ABSTRACT

A method and apparatus for establishing product items unique identity for purpose of anti-counterfeiting or anti-theft is disclosed. It employs a fluorescent taggant embedded in product item, template, digitally based Encoder and Decoder. The taggant comprising plurality of fluorescent entities which in turn may comprise such distinct geometric and spectral optical characteristics-attributes as relative locations, emission/absorption spectra, polarization degrees and post luminanc delay and duration times. Such uniqueness is determined by the presence of a combination of a wide variety of fluorescent materials used during the application. The set of fluorescent entities are result of a random process and form a product item's fingerprint. The said template is a particular digitized representation of a taggant. The Encoder may comprise a camera, LED array based activator, configured to follow a particular illumination sequence and computation unit. The said camera further comprises at least two polarizing filters and template generator and the respective controllers. The Decoder may comprise at least one camera identical to the of the Encoder, at least one template/taggant readers and a computation unit, which may be shared with the said Encoder. Product item identity is based on the fluorescent taggant uniqueness, with the later embedded into the product in a non separable way. After the extracted attribute values assiciated with the taggant, are digitized. Digitazing comprises mixing with chaff (spurious) patterns of the same format, error correction, transformation in a non invertible and compression and encryption. This forms a template, embedded in the product in a readable form. The decoding comprises feature extraction of taggant, reading template and decrypting, its content, error correction, decompression. Then the extracted and the decoding results are cross-matched in order to identify the product item. Irreproducibility of a plurality of fluorescent entities and high degree of security of its digital representation due to encryption, high variability of LED patterns and non-invertible transformation is a basis of a chaosmetric anti-counterfeiting solution disclosed in the present invention.

### REFERENCES CITED

The below references are incorporated by the reference herein in their entirety and relied upon.

U.S. PATENT DOCUMENTS

| | | | |
|---|---|---|---|
| Application 2010/0062194 | A | Jun. 6, 2002 | Crane, Prehar, CA |
| Application 2002/0066543 | A | Jun. 6, 2002 | Lilly. |
| Application 2003/0003323 | A | Jan. 2, 2003 | Murakami, Shizuoka, Akahori, et al. |
| Application 2013/0270457 | A | Oct. 17, 2013 | Boday, Wertz |
| Application 2004/0084893 | A1 | May 6, 2004 | Zhigang Fan et al. |
| Application 2006/0104103 | A1 | May 18, 2006 | Joseph Colineau et al. |
| Application 2007/0028107 | A1 | Feb. 1, 2007 | Russell Paul CoWburn |
| Application 2012/0298743 | A1 | Nov. 29, 2012 | Svyatoslav Voloshynovskyy et al. |
| U.S. Pat. No. 8,034,398 B2, 2011 | A | Jun. 6, 2002 | Gary Ross, |
| U.S. Pat. No. 8,287,993 B2, 2012 | A | Jun. 6, 2002 | Xio-Dong, Fremont, CA |
| U.S. Pat. No. 7,289,205 B2 | A | Oct. 30, 2007 | Yaroslaysky et al. |
| U.S. Pat. No. 7,821,675 B2 | A | Jan. 25, 2011 | Coyle et al. |
| U.S. Pat. No. 7,874,489 B2 | A | Jan. 25, 2011 | Mercolino |
| U.S. Pat. No. 4,568,141 | A | Feb. 4, 1986 | Gregor Antes et al. |
| U.S. Pat. No. 5,363,202 | A | Nov. 8, 1994 | Yutaka Udagawa et al. |
| U.S. Pat. No. 5,533,144 | A | Jul. 2, 1996 | Zhigang Fan et al. |
| U.S. Pat. No. 5,708,717 | A | Jan. 13, 1998 | Alfred Alasia et al. |
| U.S. Pat. No. 6,425,606 | B1 | Jul. 30, 2002 | Ying-Tsung Lu et al. |
| U.S. Pat. No. 6,553,136 | B1 | Oct. 28, 1999 | Renato Keshet et al. |
| U.S. Pat. No. 6,868,174 | B2 | Nov. 29, 2000 | William A.Fuss et al. |
| U.S. Pat. No. 7,222,791 | B2 | May 29, 2007 | Andre Heilper |
| U.S. Pat. No. 8,245,932 | B2 | Aug. 21, 2012 | Didier Gouellbo |
| U.S. Pat. No. 8,249,350 | B2 | Aug. 21, 2012 | Svyatoslav Voloshynovskyy et al. |
| U.S. Pat. No. 8,542,871 | B2 | Sep. 24, 2013 | Svyatoslav Voloshynovskyy et al. |
| U.S. Pat. No. 8,705,873 | B2 | Apr. 22, 2014 | Svyatoslav Voloshynovskyy et al. |
| U.S. Pat. No. 8,243,930 | B2 | Aug. 14, 2012 | Scott C.Harris et al. |

FOREIGN PATENT DOCUMENTS

| | | | |
|---|---|---|---|
| EP 1096 433 | A2 | 02.05.2001 | Keshet, Renato |
| EP 1564 680 | A1 | 17.08.2005 | Axalto S.A, Carte |
| Application 88309627.3 | A2 | 14.10.201988 | THOMAS DE LA RUE |

### OTHER PUBLICATIONS

[1] Dina M. Bronshtein, Counterfeit Pharmaceuticals in China: could changes bring stronger protection for intellectual property rights and human health?, 2008 Pacific Rim Law And Policy Journal Association.
[2] Thomas H. Chia and Michael J. Levene, Detection of counterfeit U.S. paper money using intrinsic fluorescence lifetime, 23 Nov. 2009 ,v ol. 17, No. 24, OPTICS EXPRESS 22054
[3] Qijie Chen, Fushan Chen, Yongxian Yan, Fluorescence Polarization Technical Resource Guide, Trademarks and Patents, bioresourses.com, in Chen et al., 2013, Editorial Quantum dots for paper: Bioresourses, 8(1), 6-7, Fourth Edition
[4] Amidror, S Chosson and R D Hersch, Moire methods for the protection of documents and products: A short survey, Journal of Physics: Conference Series 77 (2007) 012001.
[5] Peiwei Gong, Jinqing Wang, Weiming Sun et al. Tunable photoluminescence and spectrum split from fluorinated to hydroxylated graphene
[6] Erin Hendrick, Margaret Frey, Erik Herz, Ulrich Wiesner, Cellulose Acetate Fibers with Fluorescing Nanoparticles for Anti-counterfeiting and pH-sensing Applications, Journal of Engineered Fibers and Fabrics, Volume 5, Issue 1-2010
[7] Jasco, Inc Fluorescence Detection of Counterfeit US Currency
[8] Jamie Kern, Synthesis of a Unique Fluorescent Material to Print onto Medications for use in the Anti-Counterfeiting of Pharmaceuticals, an on-line publication
[9] Sokolov, S. Naik, Novel type of fluorescent silica Nanoparticles: towards ultra bright silica nanoparticles, Dept. of Physics, 8 Clarkson Ave., Clarkson University
[10] Anja Schulz Fluorescent Nanoparticles for Ion Sensing, Dissertation, vorgelegt dem Rat der Chemisch-Geowissenschaftlichen Fakult at der Friedrich-Schiller-Universit at Jena
[11] Ajeet Singh, Shalinee Jha, Garima Srivastava, Preeti Sarkar, Prerana Gogoi, Silver Nanoparticles As Fluorescent Probes: New Approach For Bioimaging, INTERNATIONAL JOURNAL OF SCIENTIFIC TECHNOLOGY RESEARCH VOLUME 2, ISSUE 11, NOVEMBER 2013
[12] Erin Sue Hendrick,celluose acetate fibers with fluorescent nanoparticles for anti-counterfeiting purposes, Thesis Presented to the Faculty of the Graduate School of Cornell University.
[13] Bruce R. Rae, Keith R. Muir, Zheng Gong, Jonathan McKendry, John M. Girkin, Erdan Gu, David Renshaw, Martin D. Dawson and Robert K. Henderson, A CMOS Time-Resolved Fluorescence Lifetime Analysis Micro-System, Sensors 2009, 9, 9255-9274
[14] Chenming Xue, Yuhua Xue, Liming Dai, Augustine Urbas, and Quan Li. Size- and Shape-Dependent Fluorescence Quenching of Gold Nanoparticles on Perylene Dye, Adv. Optical Mater. 2013
[15] An Introduction to Fluorescence Spectroscopy, 2000 PerkinElmer, Inc.
[16] Jobin Yyvon, Measuring Silica Nanoparticles via Fluorescence Anisotropy, Technical Note FL-25.
[17] Jobin Yvon Inc. Time-Gated Separation of Lanthanide Luminescence, SPEX Fluorescence Group publication
[18] Wenguan Zhang, Lian Qin, Shengmin Zhao, Red fluorescent Organic Nanoparticles Based on Donor-Acceptor Naphthylamino Fumaronitrile, Proceedings of the 17th IAPRI World Conference on Packaging
[19] Abhishek Nagar and Anil K. Jain, On the security of non invertible fingerprint template transforms, Department of Computer Science and Engineering Michigan State University
[20] Pavel Maur, Delauney, Triangulation in 3D, Technical Report DCSE/TR-2002-03, Jan. 2002, University of West Bohemia, Pilsen, Czech Republic

ONLINE PUBLICATIONS [B] http://www.pffc-online.com/mag/brand-protection-with-micro-dots/index.html

### BRIEF DESCRIPTION OF THE DRAWINGS

FIG. 1 of the drawing represents the encoding sequence of the fluorescent dynamic chaotic pattern into an encrypted digital representation in a nonconvertible transformed form.

FIG. 2 of the drawing represents the decoding sequence of the same, the process inverse to the described in FIG. 1.

FIG. 3,4 of the drawings represents block diagrams of the system as a whole in a form of is a schematic illustration of the anti-counterfeit authentication system implementing the Encode and Decode performed by the manufacturer and the consumer respectively

FIG. 5 (prior art) shows diagram represents demonstrating physical nature of the light polarization.

FIG. 6 (prior art) shows an energy zone diagram represents demonstrating physical nature of the fluorescence.

FIG. 7 shows fluorescent points-entities, their assiciated characteristics-attributes, relative scale, rotation and shift invariant groupings such as pairs and triples.

FIG. 8 shows one possible order of fluorescent embedding into a product as a plurality of entities included into a transparent mold as a 3D fluorescent chaosmetric taggant.

### OBJECTS OF THE INVENTION

The object of the present invention is an apparatus and associated methods, based on fluorescence effect applied to brand protection or anti-theft. A plurality of randomly spaced fluorescent entities such as particles specs, dots, fibers and other inclusions with chaotically distributed properties of both static and dynamic nature embedded in a product in a non separable way form a unique taggant thus establishing a solid product item authentication. The mentioned taggant is used as a unique non reproducible product's fingerprint with its attributes encoded and stored as a template by Encoder. Positive cross match of the two performed by Decoder provides authentication.

### BACKGROUND OF THE INVENTION

Currently, manufacturers all over the world incur substantial losses due to counterfeiters illegally fabricating fake products and carrying original brand names. These forged items are difficult to identify, since they are reproduced as exact replicas of the original products, and are often indistinguishable from the genuine ones. The costs to manufacturers are accompanied by losses to consumers. The later occurs due to lost quality and serious safety issues. Such high price items as designer apparel, art collector items, safety critical products (f.e. aviation military spare parts), drugs, foods are especially vulnerable to counterfeiting because of substantial financial losses and risk to human lives involved, not to mention the reputation loss to respective companies. All mentioned factors make brand protection a critical part of the modern global markets.

Numerous anti counterfeiting approaches and technologies have been developed. Among the solutions are hard to copy high tech labels and signs on the product surface revealed only under special condition by a special sensor. Among more recent solutions are 2D bar code labels containing the product info, various tags ranging from field readable to forensic, laminated labels, various inks: DNA, Color Shift, Invisible, UV-Visible, IR-Visible, tax stamps, holograms, and thermochromics and RF IDs. These methods, however did not deliver a desired result due to a high degree of the skills exhibited by the counterfeiters motivated by high profit margins.

Recent advances in electronics, sensing (optical, audio, electrical, etc.) and information processing technology created challenges for brand protection, but also provided new tools to tackle the problem. A new family of techniques, which is often named by generic term chaosmetrics appeared.

Ontology of term chaosmetrics is analogous to the term biometrics. The field of biometrics aims at establishing a unique person's identity from its biological characteristics such as a fingerprint, face, palm, gait, etc. Similarly chaosmetrics uses a combination of random (chaotic) but measurable physical characteristics-attributes already existing or purposefully embedded into a product item in a non separable way in order to establish the item's identity.

Originally the chaosmetric applications were based mostly on markings observable in visible wavelengths on product item surface. The collections of these markings represent hard to reproduce patterns. They are often sufficiently unique to verify the product item's identity. Growing availability of CCD/CMOS sensors with increased optical resolution, and other high SNR sensors enabled measurements with a sufficient degrees of precision and resolution in order to reveal the discrepancies in product's physical characteristics of different product items.

Most importantly, many of the aforementioned characteristics, exhibit such an unreproducible complexity, which cannot be easily replicated even by a well equipped manufacturer. It quickly became apparent, that plurality of chaosmetric attributes-characteristics could serve as an identifying fingerprint or taggant of particular product item. This taggant can be used in order to provide the chosen attribute set which is sufficiently salient across the product copies, stable over time, quality neutral and extractable with the existing sensor technology. A compact representation of such a “fingerprint or template may be stored in an indexed data base or embedded directly on the product in a readable format for subsequent cross matching with the taggant content by the product buyer. An authentication apparatus and the respective method based on fluorescence phenomena is the subject of the present invention.

A number of chaosmetrics based anti-counterfeiting solutions has been developed over the last 20 years. From U.S. Pat. Nos. 4,56814 and 6,425,606 B1 it is known that optical diffraction effect can generate document specific patterns which could be used to authenticate product item or a document. A surface located key element which is used for diffraction-optical authenticating produces at least one chromatic pattern forming an optically measurable unique feature. This represents a taggant used to verify the document authenticity or a product item.

From U.S. Pat. Nos. 5,363,202, 5,533,144, 5,533,144, it is known that a fine pattern may be embedded into a document or currency which is revealed only during the copying by a copy machine in order to prevent generating copies that look very similar to the original.

From U.S. Pat. No. 5,708,717, 6,553,136 B1 and European patent No EP 1 096 433 A2, it is known that the embedded optical (image) pattern can be scrambled/encrypted or otherwise obfuscated and subsequently to be cross compared with the template which is created by a training with a purpose to protect a document against forgery. It is important to note that the image requiring large space rather than a compact feature set is proposed in this patent.

From European patent No EP 1 564 680 A1, it is known that an optical pattern, extracted from product item for the purpose of authentication may be stored in encrypted form using a private key and read for cross comparison using a public key. This patent also uses an image rather than a feature set with the same storage consequences.

From European patent No EP 1 096 433 A2, it is known that a unique visual pattern from an image on the product surface which may be further cross compared with a previously stored template using a special kernel.

From U.S. Pat. No. 6,868,174 B2, it is known that a validation code may be used for product authentication.

From US patent application 2006/0104103 A1, it is known that visual illuminated speckle patterns created from backscattering of illumination light by an embossed structure due to superposition of two materials with different refractive indecis could be used for product authentication.

From US patent application No 2008/0002882 A1, it is known that a manufacturer generated PID integrated into the product packaging and stored into the distribution data base could be cross matched, thus giving a product item identification.

From the on-line publication [B] by Alp Vision Corp, it is known that a set of hidden micro points printed over the entire surface of the primary or secondary packaging can be used for for the production authentication. Among such micro-points are the ones on the blister foil for packaged foods and medical supplies. These points may or may not be observable under visible light. They cover the whole surface of the packaging and are printed in a non reproducible way. These points may contain encrypted information, which can only be deciphered by using the encryption key. If the verification process is performed in a unique and secured place, the key is very secure.

From the U.S. Pat. No. 7,222,791 B2, it is known that authentication of a product item may be performed by cross validation of a taggant with the template (bar code, RF ID, etc.) on the product or with the information data base available to the retailer, distributor and manufacturer. Note here that the cross validation is applied here on the raw plain text data which may easily be subjected to an attack.

From US patent application No 2007/0028107 A1, it is known that a medical prescription could be reliably authenticated by using intrinsic physical properties of the medicament entitlement token in order to generate a unique signature for each token being produced. The signature then is verified through the medical network.

From US patents application No 2008/0002882, U.S. Pat. Nos. 8,249,350 B2 A1, 8,542,871 B2, US patent application No 2012/0298743 A1, it is known that manufacturer generated PIN embedded into the product packaging in a hidden form may be used for authentication of product items.

From the U.S. Pat. No. 8,245,932 B2, it is known that a physical chaotic characteristics on a product item substrate could be encoded in a bar code for further cross comparison for the item authentication.

From the Voxtel Inc publication by Photonics Online, by G. Williams, it is known that a physical chaotic pattern may be implemented as nanoparticles security coating.

From U.S. Pat. No. 8,705,873 B2, it is known that a micro structure image of a product item could serve as a chaotic unreproducible pattern for product authentication. It is also known, that a template could be made more secure by using a special type of non-invertible transformation described in the patent in addition to the encryption already covered by the on-line publication [B.]

From Fluorescent Nanoparticles for Ion Sensing Erlangung, Ph.D. Dissertation, it is known that phosphorescent materials generally have much longer after-emission lifetimes than one for a typical fluorescent process due to a different role of electron's spin. As it turns out fluorescent spin causes energy transition process to occur with faster emission rates and hence, it results in much shorter fluorescence lifetimes in the range of a few nanosecond as compared with milliseconds and above for phosphorescence which is a special case of fluorescence.

A special family of the counterfeiting optical taggants are the ones based on the effect known in non linear optics: From the aforementioned dissertation we also know that the fluorescence is a non linear optical effect which is an longer wavelength light emission after being exposed to light of a shorter wavelength. A taggant containing entities of fluorescent materials, may be embedded in a product item in a way, which may not even be observable by human eye, unless it is activated by ultraviolet illumination. The technical difficulties of manufacturing of such a taggant may often prove to be insurmountable for a counterfeiters so feature serve as a brand protection feature.

The named emission properties of some materials make them fluorescent or phosphorescent which is directly relevant to the object of this invention. The time characteristics of the phosphorescent post emission are especially important since their values are large enough so that they can be reliably measured using readily available devices, such as a cell phone camera.

From Invitrogen publication technical resource Guide for Fluorescence Polarization we know that light emitted by many fluorescent materials may have different degree of polarization which depends on the incident polarization in a complex way, and chemical composition of the material. The estimate of the degree of polarization may be performed as a weighted mean of two light magnitudes filtered by perpendicularly oriented polarized filters.

From publication Tunable photoluminescence and spectrum split from fluorinated to hydroxylated graphene by P. Gong, J. Wang et al. we know that a graphene based fluorescent material hydroxylated graphene (HOG) made from fluorinated graphene exhibits a high degree of tunable emission with wavelength ranging from greenish white (343 . . . 392 nm) to deep blue (156 . . . 94 nm) nanometers. From the 3 aforementioned references we also can conclude that all these characteristics can be a basis of a particular embodiment of a dynamic fluorescent chaosmetric solution.

From Fluorescence Hyperspectral Imaging Counterfeit Currency Detection and Analysis, by Horiba Scientific we know that: fluorescent emission spectrum depends on the chemical additions and could be tuned by changing the chemical composition of the fluorescent compound. Hence such fluorescence properties as emission and absorption spectra, polarization and time delay and time decay characteristics may be tunable and highly variable. Fluorescent logo proposed described in patent application US2013, 0270457, distinguishes a bona fide product from a counterfeit one. Such a high variability also allows chaosmetric solutions.

From Genuine U.S. Currency Production, Security Features, and Counterfeiting by Ken Huffer SAIC Phoenix Field Office, U.S. Department of Homeland Security United States Secret Service we know that fluorescent fiber features may be used for currency anti-counterfeiting.

From European patent 88309627.3 we know that fluorescent compounds can be used in the security of the printed documents, checks, banknotes, ID, credit cards etc.

From Synthesis of a Unique Fluorescent Material to Print onto Medications for use in the Anti-Counterfeiting of Pharmaceuticals by Jamie Kern we know that fluorescent particles can be used for anti-counterfeiting of pharmaceutical products. It turns out that fluorescent inks could be made safe enough to be pharmaceutical pills for human consumption.

From U.S. Pat. No. 7,874,489 B2 it is known that fluorescent dyes in the form of arrays may be used for the product authentication. We know that indica fluorescent material can provide a plurality of the emission colors which could be used for anti-counterfeiting.

From U.S. Pat. No. 8,034,398 B2 it is known that multivariate fluorescence codes may be used as secure taggants for brand protection. The codes may he a result of digitization of spectral characteristics of the fluorescent entities contained in the taggant. Indeed, high variety of the multi spectral emission characteristic could be used as a code once digitized in any readable format.

From publication US 2002/0066543 A1, it is known that fluorescent microparticles in a pigmented fluorescent coating could be utilized in order to increase the document security. A collection of such micro-particles has inclusions with salient spectral characteristics and intensities different from the background.

From US 2003/0003323 A1 it is known that it is not necessary on practice (Stokes Law) to have UV rays as activation source for the fluorescence as long as the activation/absorption source has a shorter wavelength than the emitted spectrum. Moreover the activation wavelengths may even be infrared if emitted spectrum has still a larger wavelength. Hence such infrared emitting particles with infrared activation may also be used in for anti-counterfeiting of the special document paper.

From the patent application US 2010/0062194 A1 it is known that a pattern, invisible under normal light condition and containing a plurality of the fluorescent particles may be used for the anti-counterfeiting.

From patent application US 2013/0270457 A1 it is known that fluorescent dye incorporated in silica material arranged in a human readable pattern, such as sequence of symbols can be used for anti-counterfeiting

From U.S. Pat. No. 7,289,205 B2 a method is known how fluorescence polarization imaging devices and methods, polarization of the fluorescent emission could be measured efficiently and precisely.

From the publication Silver Nanoparticles As Fluorescent Probes: New Approach for Bio-imaging by Ajeet Singh, Shalinee Jha, Garima Srivastava, Preeti Sarkar, Prerana Gogoi it is known that silver nanoparticles possessing fluorescent properties could be created using chemical reduction of silver nitrate and characterized using NMR and FT-IR and could be injected into the human body for medical imaging. The use of such particles indicates the existence of fluorescent materials which are safe for humans, hence may be used for the medical products with other purposes for anti-counterfeiting of the pharmaceutical products.

From the publication Cellulose Acetate Fibers with Fluorescing Nanoparticles by Erin Hendricket et al. it is known that fluorescent Nanoparticles such as Cornell dots incorporated in cellulose fibers could be used for anti-counterfeiting.

From Size- and Shape-Dependent Fluorescence Quenching of Gold Nanoparticles on Perylene Dye by Chenming Xue , Yuhua Xue et al. at wileyonlinelibrary.com it is known that the gold nanoparticles have fluorescent properties in the range 600 nanometers and up.

From Fluorescence Detection of Counterfeit US Currency by Jasco, Inc publication we know that fluorescent patterns may be used in for the counterfeit detection in the US currency.

From Cellulose Acetate Fibers with Fluorescing Nanoparticles for Anti-counterfeiting and pH-sensing Applications by Erin Hendrick et al. we know fluorescent particles can be used for anti-counterfeiting.

From Fluorescent Semiconductor Nanocrystal, A Proposing Fluorescent Anti-Counterfeiting material for specialty paper by Chec et al. we know that the nano-crystals can be used for the anti-counterfeiting if embedded in specialty paper. This fact is directly relevant to the object of the present invention. The time characteristics of the phosphorescent post emission are large enough so they can be easily measured. In many other cases for other fluorescent particles the emission delay times are only of the order of 10-100 nanoseconds and cannot be measured reliably using such handy and available devices as a cell phone with an appropriate software.

As it should be clear from the aforementioned, the use of fluorescence effects in its static, non encrypted, non transformed, non chaosmetrics forms, without misleading chaffs features, for the brand protection is well known and disclosed in the aforementioned patents and scientific publications. Using embedded fluorescent taggants detectable in visible light after exposure with UV light is also well known. Unfortunately many of the said non-chaosmetrics solutions may be bypassed by sophisticated counterfeiters who now have an access to modern technology. Existing chaosmetrics solutions while exhibiting a high degree of irreproducibility lacks a systematic and comprehensive framework, lacks attribute value variability, lack of template protection from a possible cryptographic attacks. Raw image based chaosmetrics solutions normally have unnecessarily high memory storage requirements, while the actual relevant chaotic information is contained in relatively few chaotic features. Hence a compact representation is possible and further improvements are still desirable. The most of aforementioned proposed chaosmetrics solutions use patterns lacking complexity, noise resistance, and variability and takes a more space in a template than it should.

The present invention discloses a novel chaosmetrics taggant type based on plurality of fluorescent entities. It also discloses two novel layers of non-cryptographic template protection such as as non invertible transformation, LED sequence encoding. Introducing the time dimension into the paradigm (dynamics), polarization, and 3D dimension into the feature geometry adds more salience to chaosmetrics attributes. All these novelties together are targeted at providing a chaosmetric solution with a higher degree of product uniqueness and more controlled template security.

### SUMMARY OF THE INVENTION

The foregoing and other issues are overcome, and other advantages are realized, in accordance with the preferred embodiments of the present invention. These advantages are a wider variety of the chaosmetrics taggant attributes, better chaosmetrics template security and better template compactness. This represents an improvement over the prior art since the application of the mentioned innovations makes the task of the counterfeiter difficult by increasing chaosmetrics complexity with fluorescent based solution through multiple levels. The present invention utilizes randomness of entities attributes for anti counterfeiting and may be utilized on a wide range types of product items in order to confirm if they are genuine. The present invention discloses a method and apparatus which provides a novel chaosmetrics taggant of a higher variability, comprising template with better error resistance and better protection from tampering, a more compact storage along with the associated Encoder and Decoder.

Chaosmetrics is a method establishing a unique product item identity with a purpose of anti-counterfeiting or anti-theft. It is based on using already existing (case I), or purposefully embedded (case II) non reproducible random characteristics of the product item or its part, which are easy to measure, performance neutral and stable within nominal environment conditions.

The present invention is centered around a particular instance of chaosmetrics fluorescent/phosphorescence effects, described in the background section. The chaos source is plurality of fluorescent entities such as specs, particles, dots, fibers, inclusions, etc. molded into a translucent medium of 2D or 3D shape. These entities have a wide variety of fluorescent static and dynamic properties-attributes, including but not limited to emission spectra, polarization, post-emission lifetimes, response times. The said properties are dependent on particular chemical composition of each entity in addition to randomness of 2D/3D geometric coordinates. Random (chaotic) relative locations of plurality of fluorescent entities along with the said properties constitute a non reproducible unique fingerprint of a product item, thus giving it a unique identity, very much like a such biometric identifier as a human fingerprint. Hence the term chaosmetrics is used.

Using chaosmetrics fluorescent entities embedded in a product item's taggant, introduction of several novel attributes, introduction of two non cryptographic security layers for template protection, are the main novelties of the present invention. The first novelty group is introduction of polarization degree, emission spectrum and the respective lifetimes as chaosmetrics properties. The second novelty group is introduction of new dimensions: such dynamic features of the fluorescent entities as the response time and the lifetime of their post illumination and the third space dimension for 3D taggant. The third group of novelties is introduction of the LED bases activation apparatus and the method in which the mentioned plurality of the fluorescent entities is activated and post processing of the received properties. Finally, the last novelty group is non invertible attribute transformation and adding chaffs entities to the template. The fake features chaffs further confuse anyone attempting to reverse engineer. In order to improve template protection since the said transformation allows to perform a match directly on the transformed representation without ever opening the original.

There are three important aspects disclosed as a part of this invention. First is taggant enriched by plurality of fluorescent entities embedded into a product item. The second aspect is attributes associated with the aforementioned entities values extraction, digitizing and storage of as a template, later in the text refereed as Encoding. The third aspect is Decoding, where the aforementioned taggant and the template are extracted and cross matched in order to verify the product's identity.

Three aforementioned aspects corresponds to three stages of the data processing. First is the embedding of the fluorescent taggant. This process may be integrated into a fabrication process specific to the product item, or in a preferred embodiment may already be present as a performance neutral byproduct of the manufacturing process. It thus creates a unique fluorescent pattern serving as a product item's “fingerprint”. As in the field of fingerprinting, there are at least two more processes: Enrollment(or Encoding) and the Verification (or Decoding).

Encoding is reading the taggant and template generation. It may comprise a chaotic fluorescent taggant creation performed by the manufacturer or as a preferred embodiment be an natural performance neutral byproduct of a normal fabrication process. The attribute value read from the aforementioned taggant may be subjected to a non invertible transformation as in [19] and may be further complemented with error correction overhead, compressed and encrypted using a private key. The introduction of these processes improves the error resistance and security of a template and makes it more compact. The first two steps are performed by the manufacturer. During the Encode process a unique combination of fluorescent attributes extracted from the taggant may also be extracted after aforementioned fluorescent entities contained in the taggant get activated by an array of LEDs emitting a particular illumination pattern. As a next step these entities further gets stored into an indexed data base or a easily readable template-representation located on the device.

The third, Decode stage, my be performed by product user or buyer: the said taggant is read along with the template, both located on the product item. Then the said tempate and the taggant may be cross matched in order to verify the authenticity. Alternatively, the said template may be located in a remote data base and get extracted remotely by applying the Decoder.

Encoder apparatus may comprise the following components. LED array based activator serving purpose of light activation pattern generation. A particular emission pattern may be designed in a fashion tailored to a particular product in order to reveal maximal salience among the fluorescent attributes being extracted. The LED array may illuminate the taggant via at least two polarized filters, which may be oriented perpendicularly relative to each other, if polarization properties are included in 2D/3D attribute list.

The Encoder may further comprise at least one camera which may posses stereo abilities. Each of its two objectives has at least one polarizing filter. The said Encoder may also include a computing device for digital processing and a template storage device placing a template into a product in a compact readable form. At least two polarizing filters may be positioned between the LED array and the product item may be used for polarization attribute measurement.

The Decoder may comprise at least one camera, and at least two polarized filers for passing the light from the product, both identical to the camera included in the Encoder. The product item may include taggant comprising a plurality of fluorescent entities located on the surface of the product and aforementioned template (characters, bar code or otherwise readable representation) located in a close proximity to each other, so that they both may be read by the same camera. The Decoder may also comprise a computation device configured to decrypt and matching the template content with the attributes extracted from the taggant and perform any other relevant computations. Decoder may also comprise of an applicable template reader and communication capabilities.

The aforementioned taggant containing characteristics-entities and associated attributes represent points of interest known in art of computer vision. A collection of the said entities may be used fo object match by the experts in the art. Another well known example of such points is fingerprint minutia actively used in art of automatic fingerprint recognition. Both mentioned groups of points of interest have a number of associated attributes possing a high degree of the scale, rotation, intensity and affine transformation invariance. While fingerprint points of interests minutia have associated locations, angles and curvatures, similarly the fluorescent particles, inclusions, fibers have associated location and emission spectra, degrees of polarization and various emission time characteristics as their respective attributes.

Further particular methods, approaches and structure of the apparatus of the subject invention will become more apparent from detailed description of embodiments together with respective drawings.

### DETAILED DESCRIPTION OF THE PREFERRED EMBODIMENTS

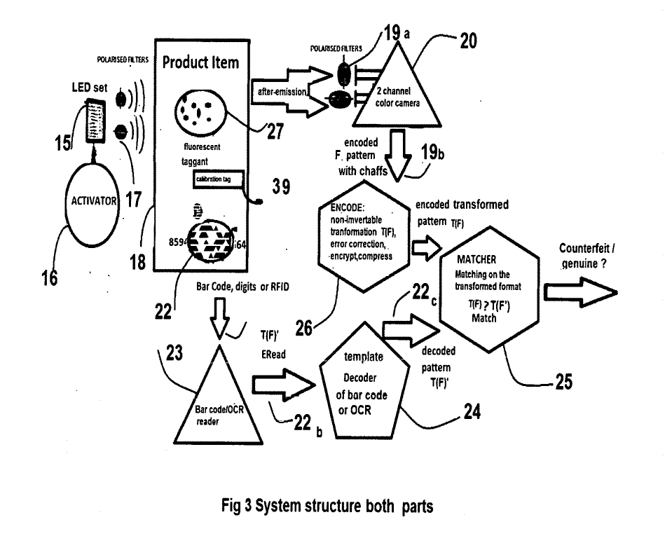

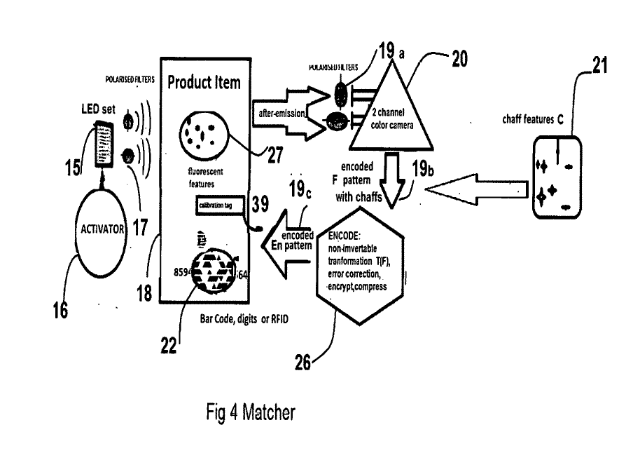

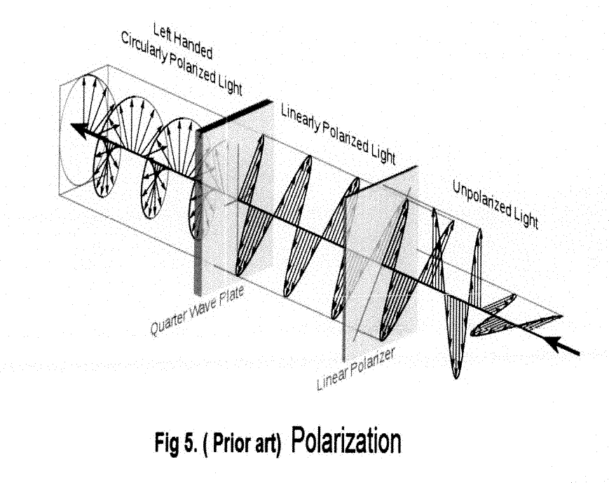

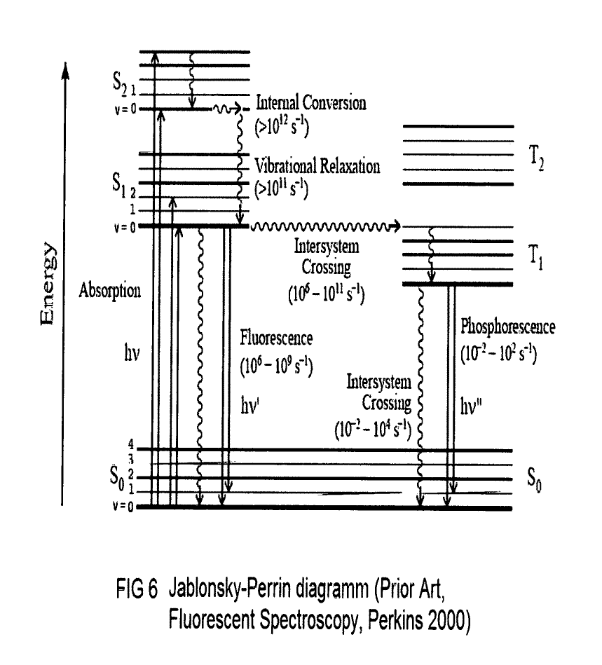

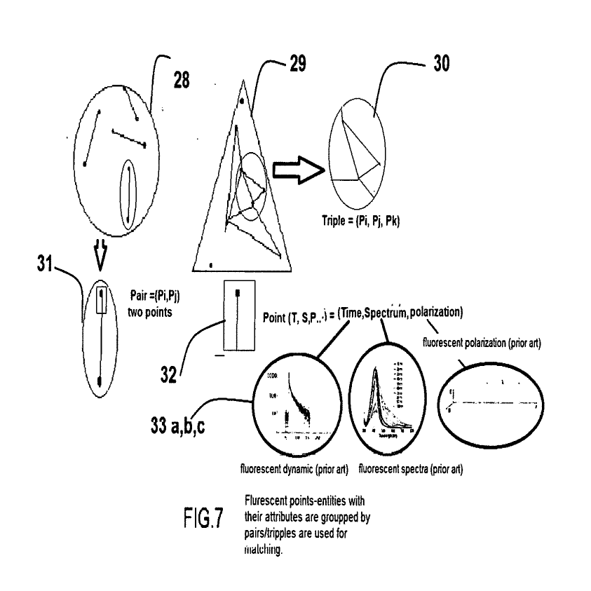

In the first embodiment of the present invention particular fluorescent taggant may be chosen for a product off line by a physical measurements and the respective attribute values of entities contained in taggant 27 of FIG. 3. Physical measurements may be performed in near visual wavelength range 10-1000 nanometer inclusive. Each of the measurement types have the respective associated attribute list. A particular instance of an attribute set depends on the product type, and may be chosen from relative locations, shape, size, spectrum, polarization and post emission times. Various fluorescent materials for each of the aforementioned entities provide the best variety and randomness taking account product items size, its shape and an operation environment. In particular, the entities size may be scaled down or up to the product size which determines a surface available for the said fluorescent taggant. Fluorescent materials must be quality neutral.

The present invention introduces the use of error correction 21, FIG. 4, non invertible attribute transformation and chaffs (attributes of fake entities), in order to increase reliability and the security of the chaosmetrics template 24, FIG. 3. Reed Solomon or any other schemes error correction may be utilized. The taggant may be a 2D label or 3D plastic transparent bubble containing randomly located and optically active inclusions-fluorescent entities

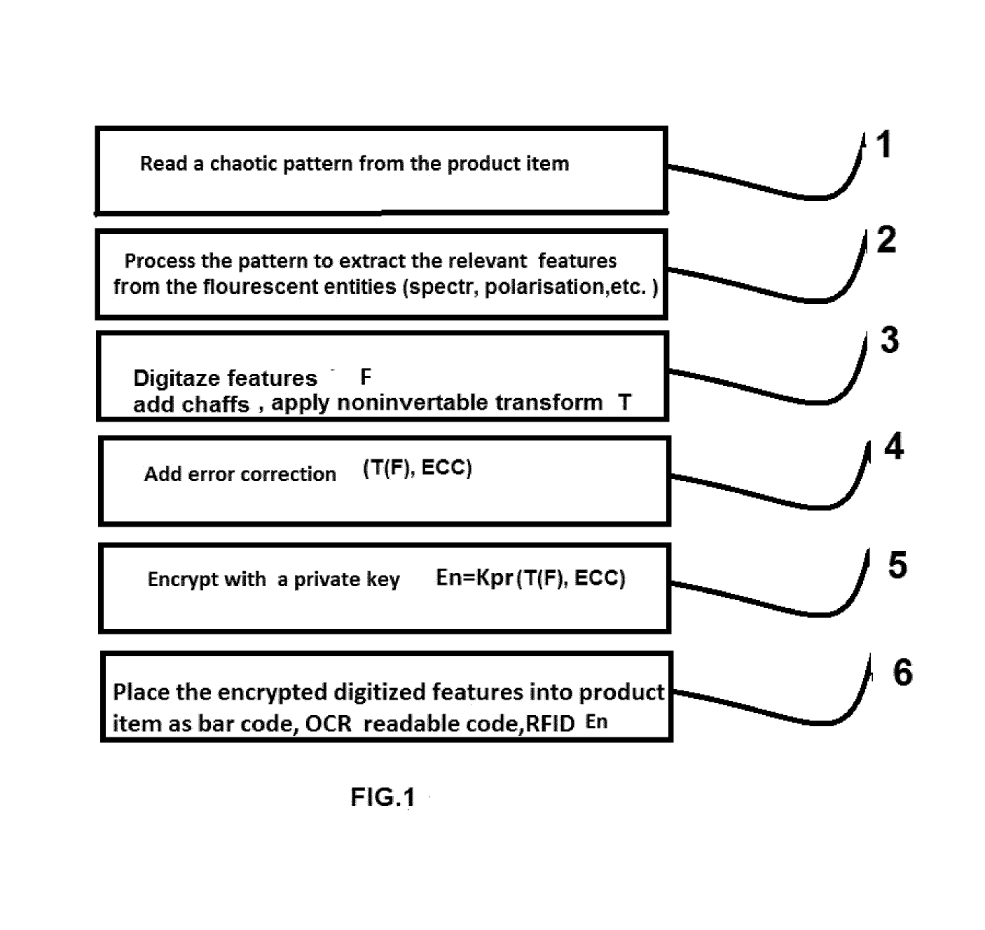

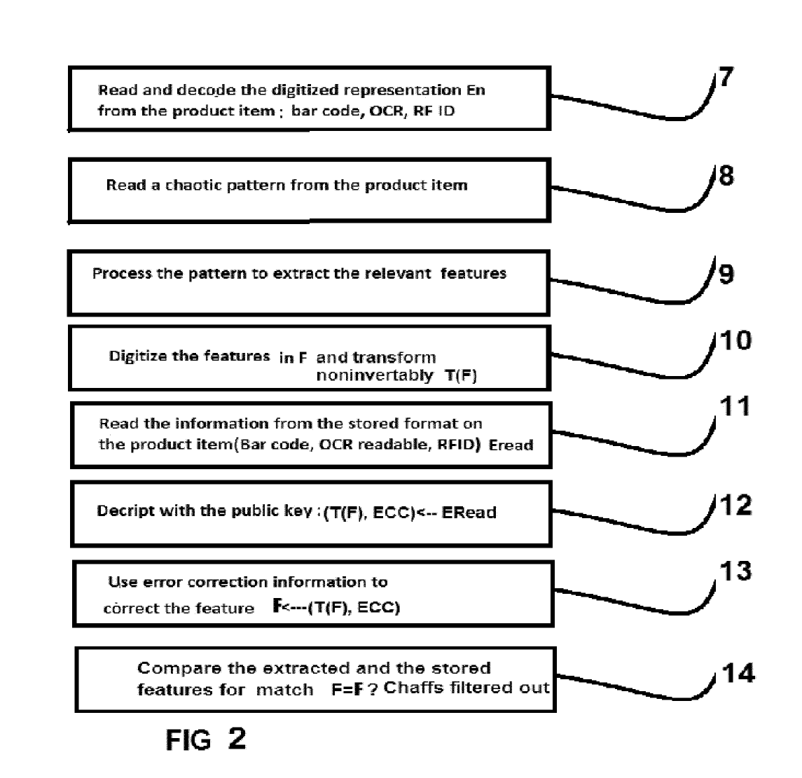

The aforementioned preferred embodiment is illustrated by FIG. 3 showing the apparatus that implements this extension textbf FIG. 1 and FIG. 2 are encoding and verification sequences performed by manufacturer and product buyer respectively. During encoding sequence (see FIG. 1), the camera I (see FIG. 3) extracts the features from the product item 18 (see FIG. 3). The feature extraction may be facilitated by LED array 15 comprising a plurality of LEDs with a wide range of emission spectra with a illumination sequence controlled by activator's 16 of FIG. 3 control logic. Attributes, extracted from plurality of fluorescent entities get digitized into F by the Digitizer 26 of FIG. 3 and it is mixed with chaffs 21 of FIG. 3. The chaffs 21 of FIG. 4 are generated automatically may comprise spurious entities, preventing an attack of the counterfeiter trying to reverse engineer the extracted feature from the said template 22. The role of the chaffs 21 is similar to the same Fuzzy Vault, described in “Handbook on Fingerprint recognition” and are well known to someone skilled in art.

Taggant 27 FIG. 3 comprising unique plurality of random fluorescent entities provides a way to identify of such a product item may already exist in the item given physical nature of the materials or a respective manufacturing process, as an alternative to its embedding.

The said taggant 27 FIG. 3 should further comprise easy to extract, hard to reproduce attributes, including polarization and absorption and emission spectra, emission times. They are chosen to be very stable to the expected operating conditions. They may posses a high variability across the product items within the same product and be neutral in respect of product's consumer's characteristics. Preferably fluorescent features in taggant 27 FIG. 3 should be where it is possible integrated into the product with consideration given to the material or manufacturing techniques in a cost effective, tamper proof way.

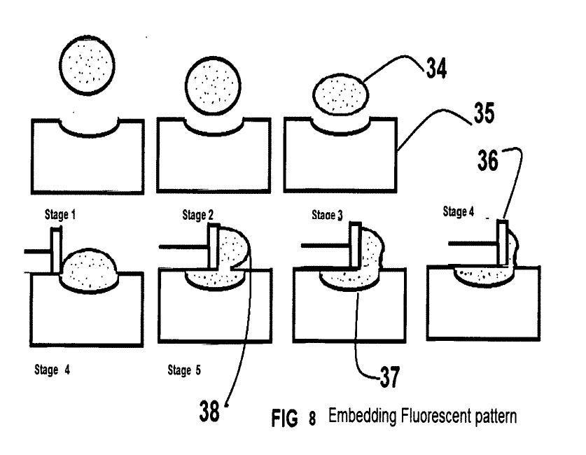

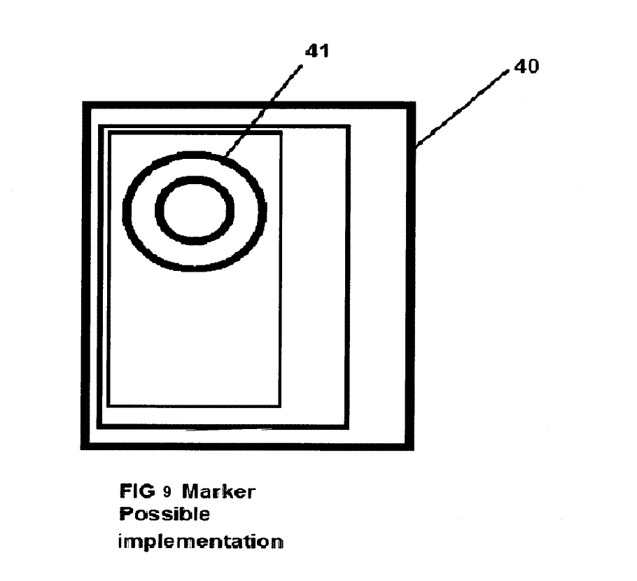

One possible way of a 3D taggant creation is shown in FIG. 8. A Small shallow “pond” opening is made on product item surface. A melted or otherwise liquefied translucent material containing a set of fluorescent entities of a random properties and location is pressed into the said opening as shown on the picture. Then the formed shape is left to cure and subsequently gets shaved off by appropriate instruments well known for someone skilled in art of glass or plastic molding.

The said template 22 of FIG. 3 comprising encodation of the aforementioned attributes is embedded into a product item as a template in a form which best suited to a product type. This may be an RF ID, character sequence, Bar code or otherwise which will be at the decoding stage readable by an RF ID reader, OCR reader, Bar code reader, or otherwise readable representation. The digitized attributes F 19 b of FIG. 3. which comprises of the fluorescent attributes and chaffs may be digitized by simple quantization of analog values they represent into a bytes and ordering these bytes according to a chosen convention (See FIG. 1). The template 22 of FIG. 3 of the feature set contained in a taggant En 19 c of FIG. 3. F is complemented with error correction overhead, encrypted and compressed (lossless compression) into En which may be stored in a readable form on the product item (FIG. 3).

A structure of the chaff set 21 elements of FIG. 3 may be identical to one of the main attributes. It may comprise values which are distinct and may be chosen randomly. Then the non-invertible transformation T may be applied and the resulting T(F) of FIG. 3 of actual and chuff features is complemented with error protection overhead E and subjected to a non-invertible transformation.

The purpose of the non-invertible transformation is a creation of another layer of security in order to deny a potential attacher the plain text. A private encryption key Kpr may be used in order to further encrypt the result (T(F) in order to obtain a template 22 En=Kpr(T(F) E) may be further encoded into a template 22 of FIG. 3 in a form of any readable format including but not limited to bar code, OCR readable symbols or RF-ID.

A particular functional form of the non-invertible transformation may be kept secret and revealed only to a bona fide customer as a part of a Decoder. Here chaotic pattern is encrypted using a private key, should only be known to the manufacturer. The cryptographic part of encoding and decoding may use a widely known RSA approach but with an important modification. The use of the private and the public key may be inverted as compared with the classical RSA. The decryption, however uses public key, which is made available to customer. A multiplicative group based on the elliptic curves, well known to someone skilled in the art, may be used for better security for the same key size with El Gamal scheme is alternatively recommended. Moreover, before the feature set is digitized, the non invertible continuous transformation T is applied. The transformation result T(F), similarly to application of cancel-able biometrics, known to someone skilled in art, should be locally smooth, but globally not smooth, thus further protecting the template from possible attacks. This allows the match to be performed over the transformed representations without opening the template, thus making it more secure. The local smoothness property of the chosen non invertible transformation will make sure that the small measurement noise in the raw attributes domain will only cause small discrepancies in the transformed range should the taggant and the template contents match. Global non-smoothness on another hand, will turn the different values of the attributes into significant discrepancies in the transformed range if the taggant and the template contents do not match. Any point matching algorithm known to someone skilled in the art of Computer Vision will fit into the described matching framework.

The activation sequence performed by the LED array based activator 15 of FIG. 3 represent yet another layer of security. The said sequence represents LED control signals, arranged in a particular undisclosed order specifying ON and OFF states for each particular LED of the said array for each moment of the activation time. Since each LED has a unique emission spectrum and the plurality of possible activation sequences is combinatorially large, and its reverse engineering represent yet another challenge for a potential attacker. Particular emission spectra and time durations should agree with a particular fluorescent materials used for the taggant 27 of FIG. 3.

In a preferred embodiments, the present invention extends the described scheme with introduction of the error correction, chaffs, encoded LED activation sequence, and non-invertible transformation over attribute values which increases the template robustness, reliability, compactness and the security.

The aforementioned plurality of chaotic fluorescent entities (with their associated attributes) located on the product. All the attributes information gets encoded in a compact form as a template. Depending on the type an applicable lossless compression technique, known to someone skilled in art, should be chosen. It may include DC subtraction followed by any type of spatial decorrelation followed by an entropy encoding technique such as arithmetic or Hofman encoding. Using a selected and compressed feature set allows a more compact representation that may be small enough for bar code or even for a sequence of the symbols.

During the Decoding stage (see FIG. 2), Camera 20 (FIG. 3) reads the stored representation off the taggant, which gets decoded, decrypted, error corrected, by the Decoder 24, FIG. 3 comprising and its output is matched by the Matcher 25 of FIG. 3 for product item authentication. The Matcher uses a number of point matching techniques well known to someone skilled in art. The positive match indicates that the product is genuine. It is recommended to use of the transformed attribute values instead of raw signal, along with the activator. For better security the matcher may operate on the transformed representation rather than on the original one. This way the expected taggant content is never exposed, even if the a perpetrator manages to brake the cryptographic key. Adding error correction and the chaff features disclosed in this invention is aimed at the security improvement of the said taggant. The decoding/verification sequence may be performed by the buyer of the product item.

Measurement of such physical attributes as spectrum, polarization degree, of each fluorescent entity comprising the taggant may be executed according to its definition given in [3] Chen et al. Estimation of time related dynamic characteristics of the said fluorescent entities may be performed according to [2], Chia et al. Both groups of the measurement are known to someone skilled in art.

Unlike the full representation of the image of the prior art described in U.S. Pat. No. 8,243,930 B2, only a transformed, compressed, complemented with error correction overhead added, taggant attributes are used. The attributes (spectrum, polarization, dynamic characteristics, relative locations) are random, their combination is unique, and but may be further compressed by an appropriate type of lossless compression. The attributes-features already require much less storage than full image in pre-compressed format, normally used in image based chaosmetrics. The compression will allow a compact representation of the chaotic information sufficiently small in order to be stored in the product item. Moreover attributes, extracted from the taggant 27, FIG. 3.0, may be unordered and represent a ‘bag’ so that they do not have to be necessarily aligned. Because of this fact missing or spurious features do not necessarily cause a failure of the authentication, and make template reverse engineering difficult.

The matching of the aforementioned collection of fluorescent attributes may be performed as a point matching directly on the transformed attributes values. A variation of point matching framework known as minutia matching to someone skilled in art of computer vision or fingerprint matching may be applied. The plurality of fluorescent points-entities along with their respective transformed attributes may be grouped in translation, rotation invariant groups pairs or triples shown in FIG. 7, extracted by Delauney triangulation and used for matching. Instead of actual distances the transformed relative distances are used (or their non invertible transformation) and instead of the minutia angles the transformations of such fluorescent attributes as spectrum, polarization degrees, dynamic characteristics 33 (a,b,c) of txtbf FIG. 7 are used. The marker comprises a set of lines and circles 40 ,41 FIG. 9. is used for image registration. The marker is applied on the product in immediate proximity to the taggant.

A close match requires similar attribute values between the attributes 33 a,b,c of FIG. 7 stored in the template 22 of FIG. 3 and the extracted from the taggant, 27 of FIG. 3. A number of distance metrics for aforementioned attributes has been developed, known for a one skilled in the art. In the presented approach the attributes from the stored template and the ones extracted from the taggant are cross matched to each other according their respective attributes. Each of the mentioned point-entities has an associated attribute sets and may be use without a particular order as a bag of features, similarly to a fingerprint minutia set. In addition to the attribute sets the relative pairwise distances between the feature pairs on the template and product features are matched. In this method the chaff features will have attributes and assumed relative distances distinct from the real features and thus will be filtered out if the product item is genuine. In all other respects the Matcher can be chosen from a number of minutia matchers well known to someone skilled in art.

The second embodiment is a special case of the plurality of chaotic fluorescent entities which represents a product item “fingerprint” of the embodiment 1 with a 2D taggant. A 3D plastic transparent bubble with embedded florescent entities is its extension. A transparent mass with the inclusions is melted down, mixed with the aforementioned entities and embedded on a product as shown on of FIG. 8.0 by the existing molding techniques known to someone skilled in the art. The aforementioned entities possessing diverse fluorescent attributes are randomly located and provide a sufficient entropy for reliable object identification. A source of spatial and optical chaos here is thermal Brownian motion and random partial selection respectively. 3D images are extracted by 2 calibrated cameras and then by use the stereo-psis (See ‘Vision Science III—Binocular Vision Module’) technique 3D locations of the inclusions are recovered. The extracted attributes are locations and the optical values (spectra, orientation, polarization, time properties) shown at 33 (a,b,c) of FIG. 7. The analogous matching algorithm is a 3D generalization of the minutia matching commonly used in fingerprint identification. 3D generalization [20] of Delanauy triangulation may be used for 3D matcher. The encoding phase however should add a number of the chaff (fake) inclusions in order to make the template more secure as in fuzzy vault (See ‘Handbook of Fingerprint Recognition’). The rest of the procedure is the same as in the first Embodiment.

The third embodiment is a special case of the embodiment 1, applied to the paper currency counterfeit detection. It comprises application of randomly located fibers, specks, particles, or other plurality fluorescent entities possessing a collection of fluorescent attribute of random values on a uniform portion of the banknote. The associated fluorescent attributes may be encoded following the first embodiment and placed on the currency note as a part of serial number as a sequence of symbols or a bar code. This information may be placed in which may be readable by currency processing machines. Activator comprising LED array controlled by an computing device. An existing cell phone hardware may be used to implement such an activator. Alternatively, an LED array may be integrated into a cash processing machine; The digital representation of the attributes may be stored in transformed, a compressed, encrypted, as a template 22 of FIG. 3. as in the aforementioned embodiment.

An improvement in chaosmetrics based counterfeiting method and apparatus increases security by utilization of the non-invertible privately available transformation over the raw features. In this case the match is performed directly on the transformed attributes T(F). This makes a crypto atack against the private key more difficult, since the raw features are never reveled in the digital format. LED based activator further extends the security due to privately available LED activation sequence. Plurality of fluorescent entities may be embedded in a product item in such a way so that the verification digital code placed on a modality different from the one where the features were placed in order to make the job of the counterfeiter more difficult, if not practically impossible. Thus the currency note will have its unique identity and which can be verifiable.

A marker comprises of several geometrical figures lines, rectangles 41, 41 of FIG. 9 or circles of a known width may be used to provide image processing algorithms with the registration information may be included. Line thickness, relative distance and the orientation are used for taggant and template registration.

What is claimed:

1. A method and apparatus for brand protection using a chaosmetrics fluorescent taggant and the template. The aforementioned taggant comprises plurality of fluorescent and/or phosphorescent entities with random unreproducible attributes embedded in the product for further cross match with the stored template representation of the the said entities. Aforementioned plurality of fluorescent entities is arranged in a chaotic order and possesses a irreproducible combination of the values of fluorescent attributes. The plurality of the said attributes further comprise relative geometric locations of the said entities and such measurable fluorescent emission characteristics as emission spectrum, polarization degrees and emission afterlives.
A method and apparatus for storing product item's identity, further comprising digital template located on the product or in a data base. The said template further comprises a stored digital representation of the said entities in the encoded form. The said template may take a form including but not limited to bar code, symbolic sequence, RF ID. The method further comprises Encoder used to read the said taggant and store the aforementioned template. The said Encoder is configured to generate a digital template; The digitization further comprises adding chaffs, non-invertible transformation, analog to digital conversion, adding error correction overhead, compression, an encryption using a private key available only to the manufacturer.
A method and apparatus for verification of the product item's identity comprising Decoder used to read the said taggant and the template and cross match their respective contents.

2. The apparatus of claim 1 further comprises Encoder and Decoder od claim 1, where the said Decoder further comprises Matcher. Encoder further comprises LED activation array, camera, computation unit. Decoder further comprises camera, bar code/OCR reader and computation unit. Computation unit is configured to convert a plurality of the fluorescent entities into a template. The said computation unit is configured to decode template an cross match with the said taggant. Product item comprising a fluorescent based chaosmetric taggant and a respective template comprising the fluorescent attributes of the named taggant. Matcher is configured to cross-match of the taggant and the template contents, further comprising non a invertible transformation.
An apparatus further comprises at least one 2 channel camera reading a chaotic attributes from the product item which further comprise at least one polarized filter, at least one Digitizer which applies to attributes set a non invertible transformation, compresses, encrypts it using a private key, add the error correction overhead. at least one Decoder which decrypts the template content using public key, performs error correction and decompression. It further comprises respective software. at least one Matcher which cross compares two attribute representations: one stored in the device or the data base (the said template) and the one read and decoded from the product item (the said taggant) by the Camera and Decoder; The apparatus also may comprise Camera (part of the Decoder which reads the respective stored feature representation or a Data base. It also may further comprise the LED based Activator which may comprise at least one LED array configured to emit activation light signal. The said array further comprises at least two polarization filters

3. A method and apparatus for counterfeit protection, comprising fluorescent taggant as in claim 1. The taggant further comprises a plurality of fluorescent entities. The said entities have associated respective static and dynamic attributes, further comprising relative geometric locations, polarizations. spectral characteristics, life times and response times chaosmetrics. The said dynamic properties may be included in the list of the attributes of chaotic fluorescent entities as in claim 1. The aforementioned attributes may be used for a matching technique similar to the minutia matching in human fingerprints.
A method of creation of unique product item identity with anti-counterfeiting or anti theft purpose comprising plurality of chaotic fluorescent entities embedded in the product item in a non separable way, comprising of plurality of particles, specs, fibers; wherein each mentioned entity possesses a plurality of fluorescent properties comprising such randomly valued attributes as absorption spectrum in near visible optical range 100-1000 nm, emission spectrum in near visible range 100-1000 nm, degree of polarization, dynamic properties, relative geometric distribution; dynamic properties of each entities comprising delay time, emission time, time decay characteristics; combination of relative geometric distribution comprising of 2D or 3D coordinates.

4. A method for counterfeit protection comprising 3D translucent bulb with plurality of the fluorescent entities and the apparatus as as in claims 1,2,3 with 3-dimensional relative coordinates recovered using a stereo-psis.

5. A method comprising a chaotic fluorescent entity attribute of polarization according to claim 1 comprising: the apparatus according to claim 3, wide spectrum multicolor camera, at least two polarizing filters, computation device configured to compute the degree of polarization.
An attributes-characteristics properties such as degree of polarization integrated into a fluoresce based chaosmetrics framework referred in the claim 1; A degree of polarization may be included in the list of the attributes of chaotic fluorescent entities of the claim 1. The apparatus of the claim 1 may further comprise of at least two polarized filter for both LED array and reader camera mentioned in the claims 3,4.

6. A method and apparatus comprising fluorescent entity dynamic attributes according to claim 1 further comprising the apparatus according to claim 1.2, wide spectrum multicolor camera according to claim 2,3, computation device configured to compute various dynamic characteristics-attributes of each of the fluorescent entity.

7. A method of increasing of chaosmetric template security comprising artificially generated entities (chaffs) included in the template as in claim 1,2,3.

8. A method for increasing template security as to claim 1 comprising an non-invertible transformation of each of the attributes according to claim 1 of each entities of plurality of a chaotic fluorescent entities according to claim 1. The said non-invertible transformation may be integrated into the Encoder apparatus of the claim 3; The aforementioned Matcher may be performed directly on he transformed values of the said attributes. A method implementing a non-invertible transformation may be integrated into the Encoder apparatus of the claim 2; The said transformation represent an additional protection layer against

9. A method and apparatus for increasing template security as in claim 1 comprising an array of LED used to illuminate aforementioned plurality of chaotic fluorescent entities, wherein the aforementioned array of LED is controlled to generate an activation illumination sequence by an activator; the said activator is configured to control the aforementioned sequence, at least two polarizing filters oriented perpendicularly relative to each other. An apparatus-pattern activator apparatus integrated into a Encoder apparatus as in claim 3 comprising a set of LEDs with different emotion spectra and a respective controller; The said controller may be configured to follow a particular order of emission in order to activate a particular response from the plurality of the chaosmetrics fluorescent entities as in the claim 1,2.

10. A method and apparatus of fluorescent chaosmetrics as in the claims 1,2 applied for the anti-counterfeiting of the currency banknotes, checks, or other documents with an additional numeric template is placed on banknote.

11. A method and apparatus comprising fluorescent dynamic chaosmetrics taggants for cross verification of high price items merchandise in order to avoid stolen merchandise: using taggants linked to to VIN numbers in the car; In such a method the apparatus from the claim 1,2 is used with plurality of the fluorescent entities applied in various places of the said high value item in an event of an ownership transfer; A Decoder from the claim one may be executed as a claims 1,2 with an camera and an appropriate application software program that configures the said cell phone to execute all the actions of the said decoder comprising reading of the fluorescent entities, reading a bar code or symbolic template, decrypting the template and matching it to the said fluorescent entities; A template as in claim 1,2,3 may be stored remotely and retrieved via cell phone connection with the verified bona fide party; A positive match would indicate a genuine ownership of the product item.

12. Point of interest Matcher as in claim 1,2 based on the attributes set subjected to the non invertible transformation of the claim 8

13. A marker comprising a distinct, but simple florescent pattern such as a set of lines and/or concentric circles used as a finding pattern for image processing registration of taggant and the template as in claims 1,2,3
